(19) United States
(12) Patent Application Publication
(10) Pub. No.: US 2010/0134478 A1
(43) Pub. Date: Jun. 3, 2010

(54) PLASMA DISPLAY AND DRIVING METHOD THEREOF

(76) Inventor: Jang-Ho Moon, Suwon-si (KR)

Correspondence Address: CHRISTIE, PARKER & HALE, LLP, PO BOX 7068, PASADENA, CA, 91109-7068, US

(21) Appl. No.: 12/547,459

(22) Filed: Aug. 25, 2009

(30) Foreign Application Priority Data
Dec. 1, 2008 (KR) 10-2008-0120666

(51) Int. Cl. G09G 3/28; G09G 5/00

(52) U.S. Cl. 345/214; 345/60

(57) ABSTRACT

A plasma display device includes a controller for generating and outputting scan data corresponding to a scan electrode to which a scan pulse is applied during an address period, and outputting the same to a scan integrated circuit having a plurality of output terminals coupled to the scan electrodes for driving the scan electrodes. During an address period, the scan integrated circuit applies a first voltage through an output terminal corresponding to the scan data, and applies a second voltage that is greater than the first voltage through another output terminal. The configuration enables the plasma display device to freely control the order of the scan electrodes to which the first voltage is applied according to the scan data.

### CROSS-REFERENCE TO RELATED APPLICATION

This application claims priority to and the benefit of Korean Patent Application No. 10-2008-0120666 filed in the Korean Intellectual Property Office on Dec. 1, 2008, the entire contents of which are incorporated herein by reference.

### BACKGROUND OF THE INVENTION

1. Field of the Invention

The present invention relates to a plasma display device and a driving method thereof.

2. Description of the Related Art

A plasma display device is a display device that utilizes a plasma display panel (PDP) for displaying characters or images by using plasma generated by a gas discharge.

Plasma display devices conventionally divide one frame into a plurality of subfields and drive the subfields, and display gray levels by a combination of weight values of the displayed subfields from among the plurality of subfields. In an address period of each subfield, a scan pulse is sequentially applied to a plurality of scan electrodes, and address pulses are selectively applied to a plurality of address electrodes to select light emitting cells and non light emitting cells. In a sustain period of each subfield, an image is actually displayed by a sustain discharge performed by the light emitting cells.

For example, because plasma display devices conventionally use a shift register to sequentially apply a scan pulse to a plurality of scan electrodes, the ability to vary the order of applying the scan pulse is limited, and because the scan pulse is applied to the corresponding scan electrode even when the scan line formed by the scan electrode from among a non-display area or a display area having no light emitting cell, it is very inefficient in time and power consumption.

The above information disclosed in this Background section is only for enhancement of the understanding of the background of the invention and therefore it may contain information that does not form the prior art that is already known in this country to a person of ordinary skill in the art.

### SUMMARY OF THE INVENTION

In one aspect, the present invention relates to a plasma display device for controlling a scan order and a driving method thereof.

In another aspect, the present invention relates to a plasma display device for reducing a scan time and power consumption and a driving method thereof.

An exemplary embodiment of the present invention includes a plurality of scan electrodes, a controller, and at least one scan integrated circuit.

The plurality of scan electrodes are coupled to a plurality of discharge cells.

The controller generates and outputs scan data corresponding to a scan electrode to which a scan pulse is applied during an address period.

The at least one scan integrated circuit includes a first voltage terminal, a second voltage terminal, a data input terminal for receiving the scan data, and a plurality of first output terminals coupled to the plurality of scan electrodes. Further, the at least one scan integrated circuit is configured to set a voltage at a first output terminal to correspond to a voltage at the first voltage terminal during the address period, and to set a voltage at other first output terminals to be a voltage at the second voltage terminal, where the first output terminal is selected in accordance with the scan data.

Another embodiment of the present invention is a method of driving a plasma display device including a plurality of scan electrodes and a scan integrated circuit having a first voltage terminal for receiving a first voltage and a second voltage terminal for receiving a second voltage. The scan integrated circuit is configured to transmit the first voltage or the second voltage to the plurality of scan electrodes through a plurality of output terminals coupled to the plurality of scan electrodes.

Scan data corresponding to a scan electrode to which a scan pulse will be applied are generated and are output to the scan integrated circuit during an address period, and the first voltage at the first voltage terminal is transmitted to a scan electrode corresponding to the scan data, and the second voltage at the second voltage terminal is transmitted to the other scan electrodes.

Yet another embodiment of the present invention provides a plasma display device including a plurality of scan electrodes, a controller, and a plurality of scan integrated circuits.

The plurality of scan electrodes are coupled to a plurality of discharge cells.

The controller divides the plurality of scan electrodes into a plurality of groups, generates and outputs scan data corresponding to a scan electrode to which a scan pulse is applied during an address period, and outputs a plurality of chip enable signals.

The plurality of scan integrated circuits include a first voltage terminal and a second voltage terminal, a chip enable signal input terminal for receiving a corresponding chip enable signal from the plurality of chip enable signals, a data input terminal for receiving the scan data, and a plurality of first output terminals coupled to respective groups of scan electrodes among the plurality of scan electrodes. The scan integrated circuits are configured to set a voltage at a first output terminal corresponding to the scan data to be a voltage at the first voltage terminal in the address period, and to set a voltage at other first output terminals to be a voltage at the second voltage terminal.

According to the exemplary embodiment of the present invention, the order of the Y electrodes to which a scan pulse is applied in the address period can be freely controlled. Also, because the scan pulse may not be applied to the Y electrode formed in the non-display area or the scan line with no light emitting cell, the address period and power consumption can be reduced and dark room contrast can be improved.

### BRIEF DESCRIPTION OF THE DRAWINGS

FIG. 1 is a block diagram showing a plasma display device according to an exemplary embodiment of the present invention.

FIG. 2 is a timing diagram showing a driving waveform of a plasma display device according to an exemplary embodiment of the present invention.

FIG. 3 is a schematic diagram showing a scan electrode driver according to an exemplary embodiment of the present invention.

FIG. 4 is a block diagram showing the scan integrated circuit shown in FIG. 3 according to an exemplary embodiment of the present invention.

FIG. 5 is a schematic diagram showing the selector shown in FIG. 4 according to an exemplary embodiment of the present invention.

FIG. 6 is a schematic diagram showing the output circuit shown in FIG. 4 according to an exemplary embodiment of the present invention.

FIG. 7 is a schematic diagram showing the scan driver according to another exemplary embodiment of the present invention.

FIG. 8 is a flowchart of a process carried out by a scan driver shown in FIG. 7 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising,” will be understood to imply the inclusion of stated elements but not the exclusion of any other elements.

Wall charges represent charges formed and accumulated on a wall (e.g., a dielectric layer) close to an electrode of a discharge cell. The wall charges are not in physical contact with the electrode, but the wall charges will be described as being “formed” or “accumulated” on the electrode. Also, a wall voltage means a potential difference formed on the wall of the discharge cell by the wall charges.

A plasma display device according to an exemplary embodiment of the present invention and a driving method thereof will now be described with reference to the accompanying drawings.

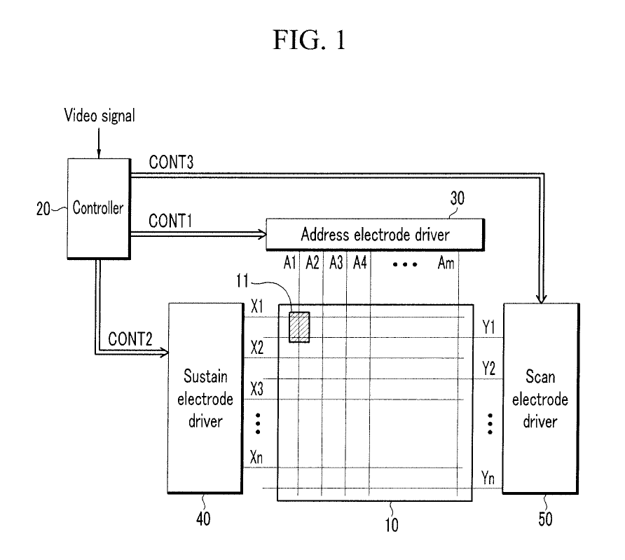

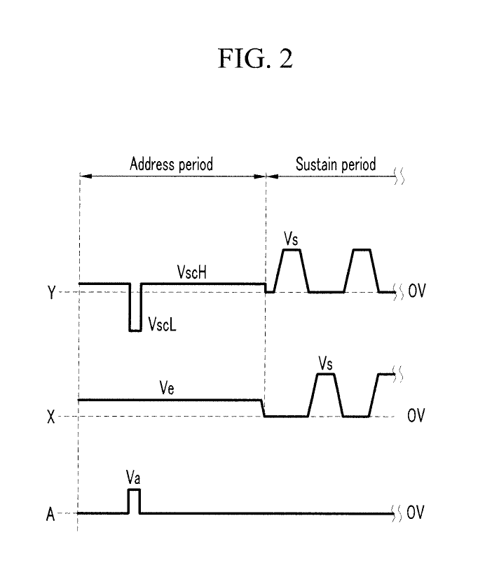

FIG. 1 shows a plasma display device according to an exemplary embodiment of the present invention, and FIG. 2 shows a driving waveform of a plasma display device according to an exemplary embodiment of the present invention.

Referring to FIG. 1, the plasma display device includes a plasma display panel (PDP) 10, a controller 20, an address electrode driver 30, a sustain electrode driver 40, and a scan electrode driver 50.

The PDP 10 includes a plurality of address electrodes (A electrodes) A1-Am extending in a column direction, and a plurality of sustain electrodes (X electrodes) X1-Xn and a plurality of scan electrodes (Y electrodes) Y1-Yn extending in pairs in a row direction. The X electrodes X1-Xn correspond to the Y electrodes Y1-Yn, and the X electrodes X1-Xn and the Y electrodes Y1-Yn are configured to perform a display operation for displaying an image in the sustain period. The Y electrodes Y1-Yn and the X electrodes X1-Xn are arranged to cross the A electrodes A1-Am. Here, the Y electrodes Y1-Yn form scan lines to which scan pulses are applied in the address period, and the A electrodes A1-Am form address lines to which address pulses are selectively applied in the address period. Discharge spaces at crossing regions of the A electrodes A1-Am and the X and Y electrodes X1-Xn and Y1-Yn form discharge cells (hereinafter, cells) 11. The PDP 10 described hereinabove is only one exemplary embodiment, and a panel with another configuration to which a driving waveform to be subsequently described is also applicable to the present invention.

The controller 20 receives video signals during one frame to generate an A electrode drive control signal CONT1, an X electrode drive control signal CONT2, and a Y electrode drive control signal CONT3, and outputs them to the address, sustain and scan electrode driver 30, 40, and 50, respectively. Here, the Y electrode drive control signal CONT3 includes scan data SDATA, control signals OC1 and OC2, a chip enable signal CE, a latch enable signal LE, and a clock signal CLK. Further, the controller 20 divides one frame into a plurality of subfields with weight values, and drives the subfields. The controller 20 uses the video signal for one frame to generate subfield data for indicating light emitting/non light emitting states of a plurality of cells 11 in a plurality of subfields. For example, when one frame includes eleven subfields with weight values 1, 2, 3, 5, 8, 12, 19, 28, 40, 59 and 78, the image data with the 120 gray level can generate the subfield data of “10011011010” from the weight value of each subfield. Here, “10011011010” corresponds to the subfields sequentially from the first one to the last one, ‘1’ represents that the discharge cell emits light at the corresponding subfield, and ‘0’ represents that the discharge cell does not emit light at the corresponding subfield.

The controller 20 sequentially outputs scan data SDATA corresponding to the Y electrode to which the scan pulse is applied, to the scan electrode driver 50. The scan data SDATA can be expressed by the binary numbers of 0 and 1, corresponding to the position of the Y electrode. In other embodiments, the controller 20 may sequentially output scan data SDATA for indicating the Y electrode corresponding to the scan line on which the light emitting cells are located by using the subfield data. Here, the subfield data is “1” for a scan line corresponding to one or more light emitting cells in each subfield.

The address electrode driver 30 applies a driving voltage to the A electrodes A1-Am according to the A electrode drive control signal CONT1 provided by the controller 20.

The sustain electrode driver 40 applies a driving voltage to the X electrodes X1-Xn according to the X electrode drive control signal CONT2 provided by the controller 20.

The scan electrode driver 50 applies a driving voltage to the Y electrodes Y1-Yn according to the Y electrode drive control signal CONT3 provided by the controller 20.

In detail, referring to FIG. 2, the scan electrode driver 50 sequentially applies a scan pulse with the voltage VscL to the Y electrodes corresponding to the scan data sequentially output by the controller 20 during the address period, and the address electrode driver 30 applies an address pulse with the voltage Va to the A electrode of the light emitting cells from among the discharge cells concurrently with the scan pulse. The scan electrode driver 50 applies the voltage VscH, which is greater than the voltage VscL, to the Y electrodes to which the scan pulse is not applied, and the address electrode driver 30 applies a reference voltage (e.g., 0V) to the A electrodes to which the address pulse is not applied. An address discharge occurs at the cells corresponding to the A electrodes to which the address pulses are applied while the voltage VscL is applied to the corresponding Y electrodes, so that wall charges are formed on the cells.

In the sustain period of an exemplary embodiment, the scan electrode driver 50 applies sustain pulses alternately having a high level voltage (e.g., Vs in FIG. 2) and a low level voltage (e.g., 0V in FIG. 2) to the Y electrode, having as many pulses as the number of the weight value of the corresponding subfield. The sustain electrode driver 40 applies sustain pulses with the opposite phase of the sustain pulse applied to the Y electrode, to the X electrode. Accordingly, the voltage difference between the Y electrode and the X electrode alternately has the voltage Vs and the voltage −Vs, and a sustain discharge repeatedly occurs at the light emitting cells, e.g., for a predetermined number of times. In an alternative embodiment, in the sustain period, the sustain pulse with the voltage Vs and the voltage −Vs can be applied to one of the Y electrode and the X electrode, and 0V can be applied to the other one thereof. Since the voltage difference between the Y electrode and the X electrode has the voltage Vs and the voltage −Vs, a sustain discharge occurs at the light emitting cells.

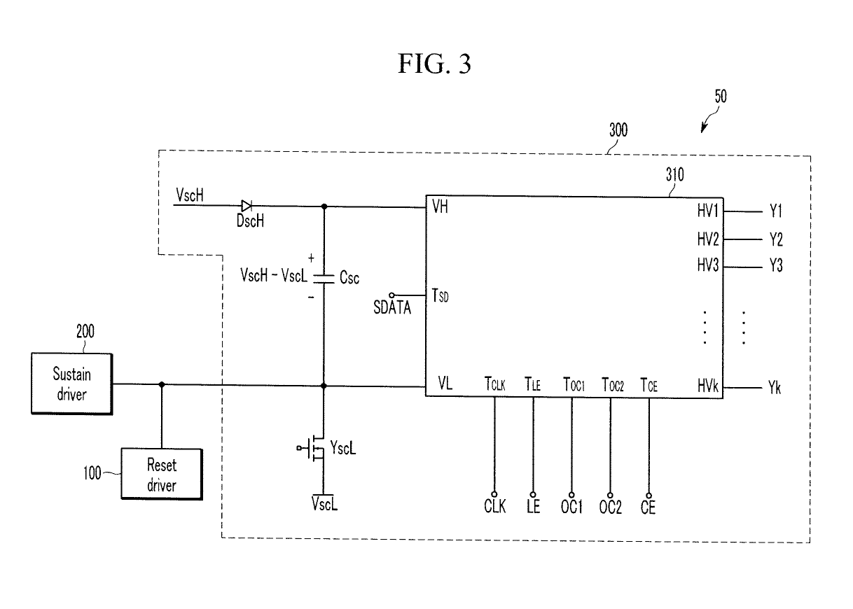

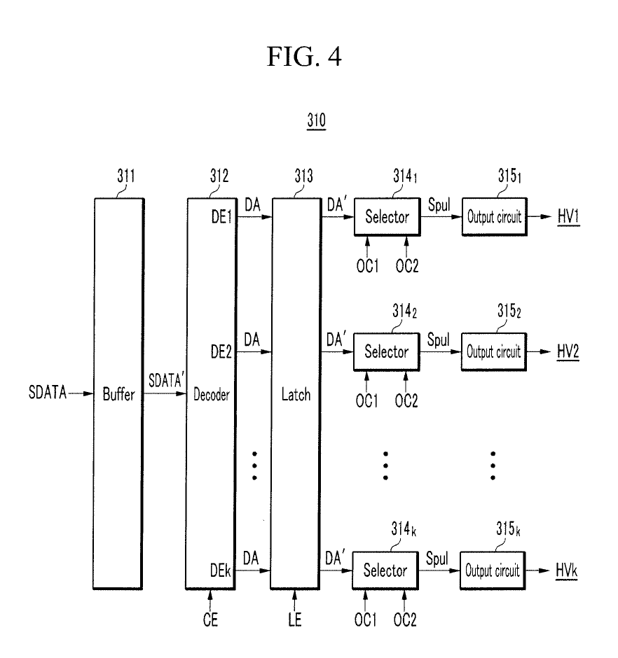

FIG. 3 shows a scan electrode driver according to an exemplary embodiment of the present invention, and FIG. 4 shows a scan integrated circuit shown in FIG. 3.

Referring to FIG. 3, the scan electrode driver 50 includes a reset driver 100 and a sustain driver 200 and scan driver 300, and the scan driver 300 includes a scan integrated circuit (IC) 310, a capacitor Csc, a diode DscH, and a transistor YscL.

First, the scan IC 310 includes a plurality of output terminals HV1-HVk, a high voltage terminal VH, a low voltage terminal VL, control signal input terminals T_{OC1} and T_{OC2}, a clock terminal T_{CLK}, a data input terminal T_{SD}, a latch enable signal input terminal T_{LE}, and a chip enable signal input terminal T_{CE}. The scan IC 310 is operated by a power VDD (not illustrated), control signals OC1 and OC2, a clock signal CLK, scan data SDATA, a latch enable signal LE, and a chip enable signal CE. A plurality of output terminals HV1-HVk are connected to a plurality of Y electrodes Y1-Yk, respectively. In FIG. 3, one scan IC 310 is illustrated, and a plurality of scan ICs can be used when the number k of output terminals HV1-HVk of the scan IC 310 is less than the number n of the Y electrodes Y1-Yn. For example, when n is 768 and k is 128, 6 scan ICs can be used.

The scan data SDATA includes binary numbers of 0 and 1, with the number of bits being determined by the number k of the output terminals of the scan IC 310 and the number n of the Y electrodes Y1-Yn. For example, when n is 768 and k is 128, the scan data SDATA have 7 bits. The scan data SDATA are generated by the controller 20, and the controller 20 sequentially generates the scan data SDATA corresponding to the Y electrode to which the scan pulse is applied and inputs the same to the scan IC 310.

Referring to FIG. 4, the scan IC 310 according to an exemplary embodiment includes a buffer 311, a decoder 312, a latch 313, selectors 314₁-314ₖ, and output circuits 315₁-315ₖ.

The buffer 311 receives the scan data SDATA from the controller 20 during the address period, and outputs the buffered scan data SDATA′ to the decoder 312. In this instance, the controller 20 outputs the scan data SDATA to the buffer 311 by sequentially outputting the respective bit data 0, 0, 0, 0, 1, 0 and 0 in the case of the serial interface method that is the case of the scan data of “0000100,” and the controller 20 outputs the scan data SDATA to the buffer 311 by outputting the respective bit data 0, 0, 0, 0, 1, 0 and 0 concurrently in parallel in the case of the parallel interface method that is the scan data of “0000100.”

In this instance, the parallel interface method improves the data rate compared to the serial interface.

The decoder 312 has a plurality of output terminals DE1-DEk, receives the buffered scan data SDATA′ from the buffer 311, and decodes the buffered scan data SDATA′ by utilizing the chip enable signal CE provided by the controller 20. The decoder 312 outputs a decoding signal DA having a high-level to an output terminal corresponding to decoding data from among output terminals DE1-DEk, and outputs a decoding signal DA having a low-level to other output terminals. For example, the 7-bit scan data SDATA of “0000111” can be decoded into the decimal number “7,” and the decoder 312 outputs a decoding signal DA having a high-level through the 7-th output terminal DE7, and outputs a decoding signal DA having a low-level through other output terminals DE1-DE6 and DE8-DEk. In an alternate embodiment, the decoder 312l outputs a decoding signal DA having a low-level through the output terminal corresponding to the decoding data, and outputs a high-level decoding signal DA through other output terminals.

The latch 313 receives the decoding signal DA through the output terminals DE1-DEk of the decoder 312, and outputs the latched decoding signal DA′ to the corresponding selectors 314₁-314ₖ by the latch enable signal LE provided by the controller 20.

The selectors 314₁-314ₖ each generate a pulse signal Spul for controlling the output circuits 315₁-315ₖ by using the corresponding latched decoding signal DA′ and the control signals OC1 and OC2 provided by the controller 20, and output the pulse signal Spul to the corresponding output circuits 315₁-315ₖ. The pulse signal Spul can be one or more than one pulse.

The output circuits 315₁-315ₖ have output terminals HV1-HVk, and the operation of the scan IC 310 is determined by the pulse signal Spul generated by the selectors 314₁-314ₖ.

Referring to FIG. 3, an anode of the diode DscH is connected to the power VscH for supplying the voltage VscH, and a cathode of the diode DscH is connected to the high voltage terminal VH of the scan IC 310. A first terminal of the capacitor Csc is connected to the high voltage terminal VH of the scan IC 310, and a second terminal of the capacitor Csc is connected to the transistor YscL. The capacitor Csc is charged with the scan voltage VscH-VscL. The transistor YscL is connected between the power VscL for supplying the voltage VscL and the low voltage terminal VL of the scan IC 310.

The reset driver 100 and the sustain driver 200 are connected to the low voltage terminal VL of the scan IC 310. The reset driver 100 applies a reset waveform to the Y electrodes Y1-Yn through the low voltage terminal VL of the scan IC 310 during the reset period of each subfield. The sustain driver 200 applies a sustain pulse to the Y electrodes Y1-Yn through the low-voltage terminal VL of the scan IC 310 during the sustain period of each subfield. During the reset period and the sustain period, the output circuits 315₁-315ₖ of the scan IC 310 are operable to output the voltage of the low voltage terminal VL in accordance with the control signals OC1 and OC2. In an alternate embodiment, the reset driver 100 can apply a reset waveform to the Y electrodes Y1-Yn through the high voltage terminal VH of the scan IC 310 during a rising period in the reset period of each subfield. In this instance, the output circuits 315₁-315ₖ of the scan IC 310 are operable to output the voltage at the high voltage terminal VH in accordance with the control signals OC1 and OC2.

In the address period, the transistor YscL is turned on and the scan IC 310 is operated by the control signals OC1 and OC2 so that the output circuit 315ᵢ corresponding to the output terminal Dei, for outputting a high-level decoding signal DA, may output the voltage of the low voltage terminal VL and other output circuits may output the voltage of the high voltage terminal VH. Here, i is an integer between 1 and k. In this instance, the voltage of the low voltage terminal VL is the voltage VscL and the voltage of the high voltage terminal VH becomes the voltage VscH by the turned on transistor YscL.

Therefore, the order of the Y electrodes to which the scan pulse with the voltage VscL is applied, is determined by the scan data SDATA output by the controller 20. For example, when the controller 20 outputs the scan data SDATA in the order of “0000100”, “0100000”, “0010010”, “1000001”, and “0001110”, the scan IC 310 applies the scan pulse with the voltage VscL in the order of the 4-th Y electrode Y4, the 32-nd Y electrode Y32, the 18-th Y electrode Y18, the 65-th Y electrode Y65, and the 14-th Y electrode Y14. Further, by selecting the scan data SDATA to not have a value corresponding to the position of Y electrodes formed on the scan lines without a non-display area or a light emitting cell, the address period can be reduced since no scan pulse may be applied to such Y electrodes.

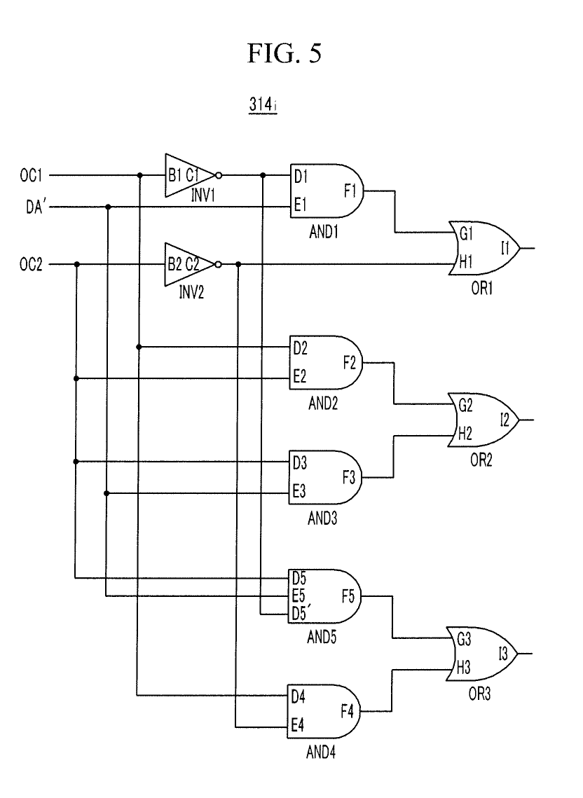

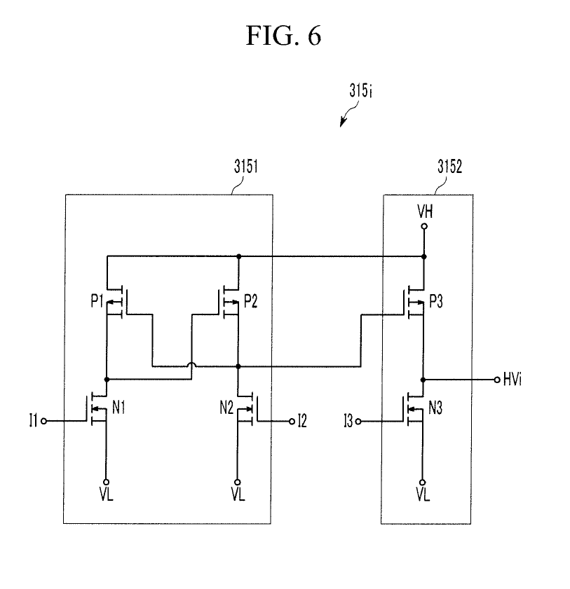

Selectors 314₁-314ₖ and output circuits 315₁-315ₖ will now be described with reference to FIG. 5 and FIG. 6.

FIG. 5 shows an exemplary embodiment of a selector shown in FIG. 4, and FIG. 6 shows an output circuit shown in FIG. 4. FIG. 5 and FIG. 6 respectively show a selector 314ᵢ from among a plurality of selectors 314₁-314ₖ and an output circuit 315ᵢ from among a plurality of output circuits 315₁-315ₖ.

Referring to FIG. 5, the selector 314ᵢ includes inverters INV1 and INV2, AND gates AND1-AND5 and OR gates OR1-OR3. The inverters INV1 and INV2 include input terminals B1 and B2 and output terminals C1 and C2, respectively, and invert levels of the input terminals B1/B2 to output them to the output terminals C1 and C2, respectively. The AND gates AND1, AND2, AND3, and AND4 each include two input terminals D1, E1, D2, E2, D3, E3, D4, and E4, and output terminals F1, F2, F3, and F4, and perform an AND operation on the levels of the two input terminals D1, E1, D2, E2, D3, E3, D4, and E4, and outputs the result of the AND operation to the respective one of the output terminals F1, F2, F3, or F4. The AND gate AND5 includes three input terminals D5, E5, and D5′ and an output terminal F5, and performs an AND operation on the levels of the three input terminals D5, E5, and D5′ and outputs the result of the AND operation to the output terminal F5. The OR gates OR1, OR2, and OR3 include two input terminals G1, H1, G2, H2, G3, and H3, and output terminals I1, I2, and I3, and perform an OR operation on the levels of the input terminals G1, H1, G2, H2, G3, and H3, and outputs the result of the OR operation to the respective one of the output terminals I1, I2, or I3. The signal output from the output terminals I1, I2, or I3 of the OR gates OR1, OR2, or OR3 is sent to the output circuit 315ᵢ. That is, according to this embodiment, the signal output from the output terminals I1, I2, and I3 of the OR gates OR1, OR2, and OR3 is the pulse signal Spul of FIG. 4.

The control signal OC1 is input to the input terminal B1 of the inverter INV1 and the input terminals D2 and D4 of the AND gates AND2 and AND4. The control signal OC2 is input to the input terminal B2 of the inverter INV2 and the input terminals E2, D3, and D5 of the AND gates AND2, AND3, and AND5. The latched decoding signal DA′ is input to the input terminals E1, E3, and E5 of the AND gates AND1, AND3, and AND5. The output terminal C1 of the inverter INV1 is connected to the input terminals D1 and D5′ of the AND gates AND1 and AND5, and the output terminal C2 of the inverter INV2 is connected to the input terminal E4 of the AND gate AND4 and the input terminal H1 of the OR gate OR1. The output terminal F1 of the AND gate AND1 is connected to the input terminal G1 of the OR gate OR1, and the output terminals F2 and F3 of the AND gates AND2 and AND3 are connected to the input terminals G2 and H2 of the OR gate OR2. Also, the output terminals F5 and F4 of the AND gates AND5 and AND4 are connected to the input terminals G3 and H3 of the OR gate OR3. The output terminals I1-I3 of the OR gates OR1-OR3 are connected to the output circuit 315ᵢ.

For example, when the control signals OC1 and OC2 respectively have a high level and a low level and the latched decoding signal DA′ has a high level, the output terminals B1 and B2 of the inverters INV1 and INV2 output a low level signal and a high level signal, respectively. Therefore, a low level signal is output at the output terminals F1-F3 and F5 of the AND gates AND1-AND3 and AND5, and a high level signal is output at the output terminal F4 of the AND gate AND4. As a result, a high level signal is output at the output terminals I1 and I3 of the OR gates OR1 and OR3, and a low level signal is output at the output terminal I2 of the OR gate OR2.

Referring to FIG. 6, the output circuit 315ᵢ includes a level shifter 3151 and an output transistor pair 3152. The level shifter 3151 includes four transistors P1, N1, P2, and N2, and the output transistor pair 3152 includes two transistors P3 and N3. In FIG. 6, the transistors P1-P3 are P channel transistors, and the transistors N1-N3 are N channel transistors. The transistors P1-P3 and N1-N3 may have a body diode.

The sources of the transistors P1-P3 and the sources of the transistors N1-N3 are connected to the high voltage terminal VH and the low voltage terminal VL, respectively, and drains of the transistors P1, P2 are connected to drains of the transistors N1, N2. A node between the transistors P1 and N1 is connected to a gate of the transistor P2, and a node between the transistors P2 and N2 is connected to gates of the transistors P1 and P3. In this instance, the gate of the transistor N1 is connected to the output terminal I1 of the OR gate OR1, the gate of the transistor N2 is connected to the output terminal I2 of the OR gate OR2, and the gate of the transistor N3 is connected to the output terminal I3 of the OR gate OR3 illustrated in FIG. 5. Therefore, on/off states of the transistors P1-P3 and N1-N3 are determined by the level of the signal output by the selector 314ᵢ. A node between the transistors P3 and N3 is connected to the output terminal HVi.

The selector 314ᵢ and the output circuit 315ᵢ determines the state of the scan IC 310 as shown in Table 1 according to the control signals OC1 and OC2 and the level of the latched decoding signal DA′.

Table 1 shows functions of the scan IC 310. In Table 1, “H” represents the high level and “L” indicates the low level. “X” denotes a “don't care” condition in which the level is not relevant. “OUT1”, “OUT2” and “OUT3” represent signals output from the output terminals I1-I3 of the OR gates OR1-OR3, and “TP3” indicates the signal input to the gate of the transistor P3. “DATA” represents the output of the output circuit 315ᵢ corresponding to the output terminal DEi for outputting the decoding signal DA, and is operated according to the level of the latched decoding signal DA′.

TABLE 1

| DA′ | OC1 | OC2 | OUT1 | OUT2 | TP3 | OUT3 | HVᵢ States |
|---|---|---|---|---|---|---|---|
| X | L | L | H | L | H | L | High |
| | | | | | | | impedance |
| X | H | H | L | H | L | L | Output VH |
| | | | | | | | voltage to |
| | | | | | | | output |
| | | | | | | | terminals |
| X | H | L | H | L | H | H | Output VL |
| | | | | | | | voltage to |
| | | | | | | | output |
| | | | | | | | terminals |
| L | L | H | L | H | L | L | DATA |
| H | L | H | H | L | H | H | |

Accordingly, when the control signal OC1 is at a low level L and the control signal OC2 is at a high level H, if the latched decoding signal DA′ is at a low level L, the transistor P3 is turned on to output the voltage of the high voltage terminal VH during the period corresponding to the pulse width of the latched decoding signal DA′, and if the latched decoding signal DA′ is at a high level H, the transistor N3 is turned on to output the voltage of the low voltage terminal VL during the period corresponding to the pulse width of the latched decoding signal DA′.

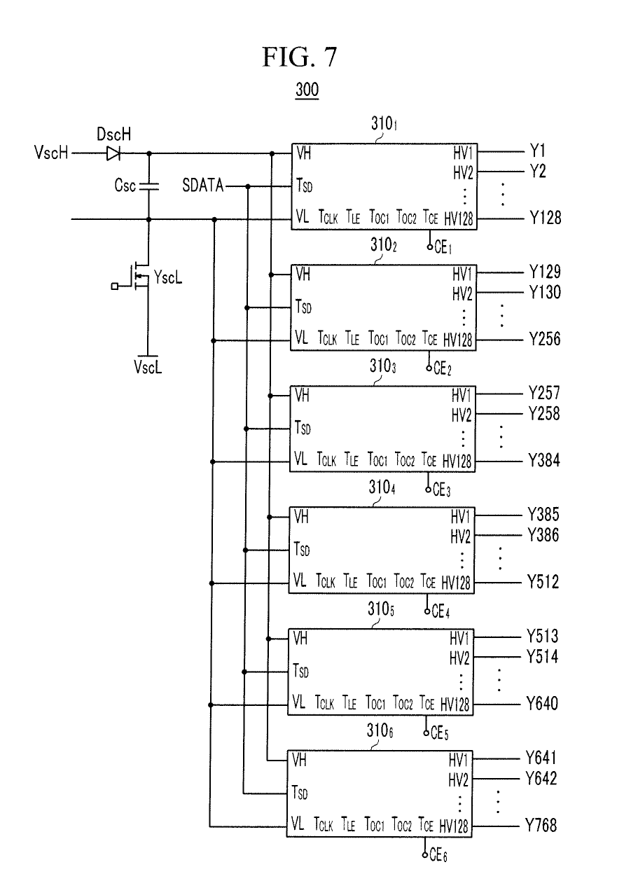

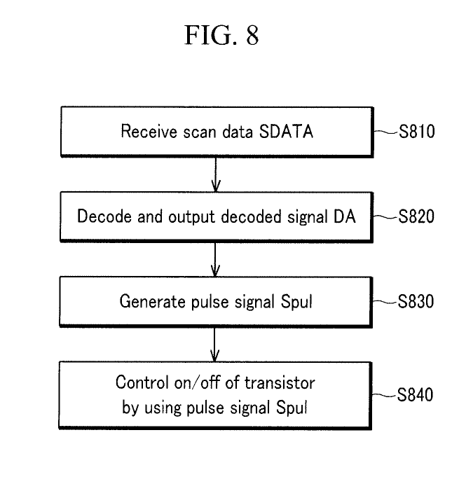

An operation of the scan driver 300 including a plurality of scan ICs will now be described with reference to FIG. 7 and FIG. 8.

FIG. 7 shows a scan driver 300 according to another exemplary embodiment of the present invention, and FIG. 8 shows a flowchart of an operation by the scan driver 300 shown in FIG. 7.

Referring to FIG. 7, the scan driver 300 includes six scan ICs 310₁-310₆. In this instance, the number of output terminals of the scan ICs 310₁-310₆ is 128, and the output terminals HV1-HV128 of the scan ICs 310₁/310₂/310₃/310₄/310₅/310₆ are connected to the Y electrodes Y1-Y128/Y129-Y256/Y257-Y384/Y385-Y512/Y513-Y640/Y641-Y768, respect The cathode of the diode DscH and a first terminal of the capacitor Csc are connected in common to the high voltage terminals VH of the six scan ICs 310₁-310₆, and a second terminal of the capacitor Csc and a drain of the transistor YscL are connected in common to the low voltage terminals VL of the six scan ICs 310₁-310₆. In this case, the controller 20 outputs the control signals OC1 and OC2, the clock signal CLK, and the latch enable signal LE to the control signal input terminals TOC1 and TOC2, a clock terminal TCLK, and a latch enable signal input terminal TLE, respectively, of the six scan ICs 310₁-310₆. The controller 20 also outputs the 7-bit scan data SDATA and the six chip enable signals CE₁-CE₆ corresponding to the six scan ICs 310₁-310₆ to select the Y electrode to which the scan pulse will be applied from among the 768 Y electrodes Y1-Y768. That is, in order to select the appropriate scan IC 310ᵢ the controller 20 applies a chip enable signal CEᵢ having a high-level to the scan IC 310ᵢ connected to the Y electrode to which the scan pulse is applied, and applies a chip enable signal CEᵢ having a low-level to the other scan ICs. The controller 20 sets the scan data SDATA depending on the order of the Y electrodes to which the scan pulse is applied from among the output terminals HV1-HV128 of the selected scan IC 310ᵢ. The scan IC 310ᵢ having received the chip enable signal CEᵢ having the high-level decodes and processes the scan data SDATA, and the other scan ICs do not process the scan data SDATA. According to an alternate embodiment, the low level can be used for the chip enable signal CEᵢ for selecting the scan IC for decoding the scan data SDATA.

For example, the case in which the scan pulse is applied to the 132-nd Y electrode Y132 from among a plurality of Y electrodes Y1-Y768 will be assumed. Since the 132-nd Y electrode Y132 is connected to the 4-th output terminal HV4 in the 2-nd scan IC 310₂, the controller 20 generates 7-bit scan data SDATA “0000100” corresponding to 4, sets the chip enable signal CE₂ to be at the high level, and sets the chip enable signals CE₁ and CE₃-CE₆ to be at the low level.

Assuming that the scan ICs 310₁-310₆ shown in FIG. 7 are substantially the same as the scan IC 310 shown in FIG. 4, buffers 311₁-311₆ of the scan ICs 310₁-310₆ receive the scan data SDATA of “0000100” from the controller 20 (S810).

The buffers 311₁-311₆ of the scan ICs 310₁-310₆ each output buffered scan data SDATA′ of “0000100” to the decoders 312₁-312₆ of the scan ICs 310₁-310₆.

The decoders 312₁-312₆ of the scan ICs 310₁-310₆ receive the buffered scan data SDATA′ of “0000100” from the buffers 311₁-311₆. In this instance, the decoder 312₂ of the scan IC 310₂ receives the chip enable signal CE₂ having a high-level from the controller 20, and decodes the buffered scan data SDATA′ of “0000100” to output a decoding signal DA to the corresponding output terminal DE4 (S820). That is, the decoder 312₂ outputs the decoding signal DA having a high-level to the 4-th output terminal DE4 corresponding to the buffered scan data SDATA′ of “0000100”, and outputs the decoding signal DA having a low-level to the other output terminals DE1-DE3 and DE5-DE128.

When receiving the chip enable signals CE₁ and CE₃-CE₆ having a low-level, the decoders 312₁-312₆ of the scan ICs 310, and 310₃-310₆ output the decoding signal DA having a low-level to all the output terminals DE1-DE128.

The latches 313₁-313₆ of the scan ICs 310₁-310₆ output the latched decoding signal DA′ output by the decoders 312₁-312₆ corresponding to the latch enable signal LE provided by the controller 20 to the selectors 314₁-314₆ of the scan ICs 310₁-310₆.

The selectors 314₁-314₆ of the scan ICs 310₁-310₆ generate a pulse signal Spul according to the latched decoding signal DA′ and the levels of the control signals OC1 and OC2 and output the same to the output circuits 315₁-315₆ of the scan ICs 310₁-310₆ (S830).

The output circuits 315₁-315₆ of the scan ICs 310₁-310₆ receive the pulse signal Spul from the selectors 314₁-314₆, and the transistors P1-P3 and N1-N3 are turned on/off according to the pulse signal Spul to determine the operation of the scan ICs 310₁-310₆. For example, referring to Table 1, the selector 314₄ of the scan IC 3102 having received a latched decoding signal DA′ having a high-level from the latch 313₄ outputs high, low, and high level pulse signals OUT1-OUT3 to the output circuit 315₄ of the scan IC 3102 according to the control signals OC1 and OC2, and the selectors 314₁-314₃ and 314₅-314₆ of the scan IC 310₂ and the selectors 314₁-314₆ of the scan ICs 310₁ and 310₃-310₆ having received the latched decoding signal DA′ having a low-level output the low, high, and low level pulse signals OUT1-OUT3 to the output circuits 315₁-315₃ and 315₅-315₆ of the scan IC 310₂ and the output circuits 315₁-315₆ of the scan ICs 310₁, and 310₃-310₆ according to the control signals OC1 and OC2. The output circuit 315₄ of the scan IC 310₂ turns on the transistors N1, N3, and P2 and turns off the transistors N2, P3, and P1 by using the high, low, and high-level pulse signals OUT1-OUT3 of the scan IC 310₂. During the period corresponding to the width of the decoding signal DA, the voltage at the low voltage terminal VL is applied to the Y electrode Y132 through the output terminal HV4 of the scan IC 310₂. Also, the output circuits 315₁-315₆ of the scan IC 310₁ and 310₃-310₆ and the output circuits 315₁-315₃ and 315₅-315₁₂₈ of the scan IC 3102 turn off the transistors N1, P2, and N3 and turn on the transistors N2, P3, and P1 by using the low, high, and low level pulse signals OUT1-OUT3. During the period corresponding to the width of the decoding signal DA, the voltage at the high voltage terminal VH is applied to the Y electrodes Y1-Y131 and Y133-Y768 through the corresponding output terminals HV1-HV131 and HV133-HV768. In this instance, the voltage VscL is applied to the Y electrode Y132 by the turned-on transistor YscL and the voltage VscH is applied to the Y electrodes Y1-Y131 and Y133-Y768.

The scan ICs 310₁-310₆ repeat the process of S810-S840 each time the scan data SDATA are input to sequentially apply the scan pulse to the Y electrodes Y1-Yn during the address period.

In the exemplary embodiment of the present invention, the controller 20 has been described to generate the scan data SDATA and the chip enable signal CE and apply the same to the scan IC 310, and further, the controller 20 can combines the scan data SDATA and the data for representing the chip enable signal CE and output the combined data to the scan IC 310.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of scan electrodes coupled to a plurality of discharge cells;
a controller for generating and outputting scan data corresponding to a scan electrode to which a scan pulse is applied from among the plurality of scan electrodes during an address period; and
at least one scan integrated circuit having a first voltage terminal, a second voltage terminal, a data input terminal for receiving the scan data, and a plurality of first output terminals coupled to the plurality of scan electrodes,
wherein the at least one scan integrated circuit is configured to set a voltage at a first output terminal of the plurality of first output terminals to correspond to a voltage at the first voltage terminal during the address period, and to set a voltage at other first output terminals of the plurality of first output terminals to correspond to a voltage at the second voltage terminal, the first output terminal of the plurality of first output terminals being selected in accordance with the scan data.

2. The plasma display device of claim 1, wherein:
the at least one scan integrated circuit comprises:
a decoder having a plurality of second output terminals corresponding to the plurality of first output terminals, the decoder for decoding the scan data, outputting a decoding signal having a first level through a second output terminal of the second output terminals corresponding to the scan data, and outputting a decoding signal having a second level through another one of the second output terminals; and
a plurality of output circuits corresponding to the plurality of first output terminals, the output circuits for outputting the voltage at the first voltage terminal or the voltage at the second voltage terminal to a corresponding one of the first output terminals according to the decoding signal of a corresponding one of the second output terminals.

3. The plasma display device of claim 2, wherein:
the controller is further configured to output a first control signal and a second control signal, and
the at least one scan integrated circuit further comprises a first control signal input terminal and a second control signal input terminal for receiving the first control signal and the second control signal, respectively, and an operation of the at least one scan integrated circuit is determined by the first control signal and the second control signal.

4. The plasma display device of claim 3, wherein:
the at least one scan integrated circuit further comprises a plurality of selectors for generating at least one pulse signal by utilizing the levels of the decoding signals output by the plurality of second output terminals and by further utilizing the first control signal and the second control signal, and
the plurality of output circuits are coupled to the plurality of selectors for receiving the at least one pulse signal, and are configured to output the voltage at the first voltage terminal or the voltage at the second voltage terminal according to the at least one pulse signal.

5. The plasma display device of claim 1, further comprising:
a transistor coupled between the first voltage terminal of the at least one scan integrated circuit and a first power for supplying a voltage corresponding to the scan pulse, the transistor for being turned on in the address period; and
a capacitor coupled between the first voltage terminal and the second voltage terminal of the at least one scan integrated circuit, the capacitor for being charged with a scan voltage when the transistor is turned on.

6. The plasma display device of claim 5, further comprising a sustain driver coupled to the first voltage terminal of the at least one scan integrated circuit, the sustain driver for applying a sustain pulse to the plurality of scan electrodes during a sustain period,
wherein the at least one scan integrated circuit is configured to set a voltage at the plurality of first output terminals to be the voltage at the first voltage terminal during the sustain period.

7. The plasma display device of claim 1, wherein the number of bits of the scan data corresponds to the number of the first output terminals of the at least one scan integrated circuit.

8. The plasma display device of claim 1, wherein the controller is configured to determine the value of the scan data according to the position of the scan electrode to which the scan pulse is to be applied.

9. The plasma display device of claim 1, wherein the controller is configured to generate the scan data so that the scan pulse is applied to a scan electrode of the plurality of scan electrodes corresponding to a light emitting cell of the plurality of discharge cells.

10. The plasma display device of claim 1, wherein:
the controller is further configured to output a chip enable signal;
the at least one scan integrated circuit further comprises a third control signal input terminal for receiving the chip enable signal; and
the at least one scan integrated circuit is further configured to set the voltage at the first output terminal of the plurality of first output terminals to correspond to the voltage at the first voltage terminal during the address period when the chip enable signal has a third level, and to set the voltage at the other first output terminals of the plurality of first output terminals to correspond to the voltage at the second voltage terminal during the address period when the chip enable signal has a fourth level.

11. The plasma display device of claim 10, wherein:
the at least one scan integrated circuit comprises a plurality of scan integrated circuits; and
the controller is further configured to set the chip enable signal transmitted to a scan integrated circuit of the plurality of scan integrated circuits to be a third level, and to set the chip enable signal transmitted to other scan integrated circuits of the plurality of scan integrated circuits to be a fourth level.

12. The plasma display device of claim 11, wherein the scan integrated circuit to which the third level chip enable signal is transmitted is configured to decode the scan data.

13. A method of driving a plasma display device comprising a plurality of scan electrodes, and a scan integrated circuit having a first voltage terminal for receiving a first voltage and a second voltage terminal for receiving a second voltage, wherein the scan integrated circuit is configured to transmit the first voltage or the second voltage to the plurality of scan electrodes through a plurality of output terminals coupled to the plurality of scan electrodes, the method comprising:
generating scan data corresponding to a scan electrode of the plurality of scan electrodes to which a scan pulse is applied and outputting the scan data to the scan integrated circuit during an address period;
transmitting the first voltage at the first voltage terminal to the scan electrode of the plurality of scan electrodes corresponding to the scan data; and
transmitting the second voltage at the second voltage terminal to other scan electrodes of the plurality of scan electrodes.

14. The method of claim 13, wherein the outputting the scan data to the scan integrated circuit comprises generating the scan data corresponding to the scan electrode of the plurality of scan electrodes that is coupled to a light emitting cell of a plurality of discharge cells.

15. The method of claim 13, wherein the outputting the scan data to the scan integrated circuit comprises generating the scan data having a value corresponding to a position of a scan electrode of the plurality of scan electrodes to which the scan pulse is applied.

16. The method of claim 15, further comprising:
decoding the scan data;
determining an output terminal of the plurality of output terminals corresponding to a value of the decoded scan data;
transmitting the first voltage at the first voltage terminal through the determined output terminal of the plurality of output terminals; and
transmitting the second voltage at the second voltage terminal through the other output terminals of the plurality of output terminals.

17. The method of claim 15, wherein a number of bits of the scan data corresponds to a number of the output terminals of the scan integrated circuit.

18. A plasma display device comprising:
a plurality of scan electrodes coupled to a plurality of discharge cells;
a controller for dividing the plurality of scan electrodes into a plurality of groups, for generating and outputting scan data corresponding to a scan electrode of the plurality of scan electrodes to which a scan pulse is applied during an address period, and for outputting a plurality of chip enable signals; and
a plurality of scan integrated circuits respectively comprising a first voltage terminal and a second voltage terminal, a chip enable signal input terminal for receiving a corresponding chip enable signal of the plurality of chip enable signals, a data input terminal for receiving the scan data, and a plurality of first output terminals coupled to respective groups of scan electrodes among the plurality of scan electrodes, wherein the scan integrated circuits are configured to set a voltage at a first output terminal of the plurality of first output terminals corresponding to the scan data to be a voltage at the first voltage terminal in the address period, and to set a voltage at other first output terminals of the plurality of first output terminals to be a voltage at the second voltage terminal.

19. The plasma display device of claim 18, wherein
the controller is configured to set a corresponding one of the chip enable signals output to a first scan integrated circuit of the plurality of scan integrated circuits to have a first level, and to set another one of the chip enable signals output to another scan integrated circuit of the plurality of scan integrated circuits to have a second level, and
the controller is further configured to concurrently output the scan data to the plurality of scan integrated circuits.

20. The plasma display device of claim 19, wherein the plurality of scan integrated circuits further respectively comprise:
a decoder having a plurality of second output terminals respectively corresponding to the plurality of first output terminals, for decoding the scan data corresponding to the chip enable signal having the first level, for outputting a decoding signal having a third level through a second output terminal of the plurality of second output terminals corresponding to the decoded scan data, for outputting a decoding signal having a fourth level through another second output terminal of the plurality of second output terminals, and for outputting a decoding signal having the fourth level to the plurality of second output terminals corresponding to the chip enable signal having the second level; and
a plurality of output circuits corresponding to the plurality of first output terminals, for outputting the voltage at the first voltage terminal or the voltage at the second voltage terminal to the corresponding said first output terminal according to a level of the decoding signal of the corresponding said second output terminal.

21. The plasma display device of claim 18, further comprising:
a transistor coupled between the first voltage terminal of the plurality of scan integrated circuits and a first power for supplying a voltage corresponding to the scan pulse, the transistor configured to be turned on during the address period; and
a capacitor coupled between the first voltage terminal and the second voltage terminal of the plurality of scan integrated circuits, the capacitor configured to be charged with a scan voltage when the transistor is turned on.

22. The plasma display device of claim 18, wherein the controller is configured to determine a value of the scan data according to a position of the scan electrode of the plurality of scan electrodes to which the scan pulse is applied.

23. The plasma display device of claim 18, wherein the controller is configured to generate the scan data so that the scan pulse is applied to the scan electrode of the plurality of scan electrodes to which a light emitting cell of the plurality of discharge cells is coupled from among the plurality of scan electrodes.
